(19) United States
(12) Patent Application Publication
(10) Pub. No.: US 2020/0341330 A1
(43) Pub. Date: Oct. 29, 2020

(54) DISPLAY CONTROL METHOD

(71) Applicant: Mitsubishi Electric Corporation, Tokyo (JP)

(72) Inventor: Manabu TANAHARA, Tokyo (JP)

(73) Assignee: Mitsubishi Electric Corporation, Tokyo (JP)

(21) Appl. No.: 16/835,596

(22) Filed: Mar. 31, 2020

(30) Foreign Application Priority Data
Apr. 24, 2019 (JP) 2019-082821

(51) Int. Cl. G02F 1/1335; H04N 13/315

(52) U.S. Cl. CPC G02F 1/133512; H04N 13/315

(57) ABSTRACT

It is an object to provide a technique capable of suppressing a reduction in a visual quality. A display device includes a display panel and a parallax harrier panel in which a plurality of openings capable of being switched into a light transmitting state and a light shielding state with respect to light of the display panel are arrayed. A display control method performs a control of bringing a predetermined number of openings adjacent to each other into a first state which is one state of the light transmitting state and the light shielding state to form a plurality of first state parts and bringing remaining openings out of the plurality of openings into a second state which is another state of the light transmitting state and the light shielding state, and a control of moving the first state parts at a pitch corresponding to two or more openings.

### BACKGROUND OF THE INVENTION

### Field of the Invention

The present invention relates to a display control method enabling a stereoscopic display.

### Description of the Background Art

Recently, a display device enabling an observer to visually recognize a stereoscopic image becomes common. In order to achieve the visual recognition of the stereoscopic image, proposed is a method of combining a display panel displaying an image for right eye and an image for left eye partially different from each other and a barrier structure of making a right eye and a left eye visually recognize the image for right eye and the image for left eye, respectively.

Known as the barrier structure is a parallax barrier system using a parallax barrier panel provided in a front side or a back side of the display panel and including a light transmitting part having a longitudinal slit shape and a shutter part (a light shielding part) having a longitudinal slit shape alternately arrayed in a lateral direction. According to this parallax barrier system, the observer can visually recognize the stereoscopic image without using dedicated eye glasses.

However, in the parallax barrier system, an area of a viewpoint where the image can be visually recognized as a proper stereoscopic image is limited. When a viewpoint of the observer is located outside this area, a 3D crosstalk in which an image for right eye and an image for left eye are mixed occurs, so that it is hard for the observer to visually recognize the stereoscopic image. Thus, proposed is a system of detecting information of a current position of a viewpoint of an observer and changing a position of a light transmitting part and a shutter part of a barrier in accordance with the position of the viewpoint to substantially enlarge the area of the viewpoint (for example, Japanese Patent No. 2973867).

For example, a liquid crystal panel is used as a parallax barrier panel capable of moving the light transmitting part and the shutter part to an optional position. The liquid crystal panel changes a voltage applied to a liquid crystal to change an orientation of liquid crystal molecules and further change a polarization state, thereby being able to control a light transmitting or non-light transmitting state of the light. in a configuration of controlling the liquid crystal using the voltage, a plurality of slit electrodes (also referred to as barrier electrodes) linearly extending on a substrate of the parallax barrier panel are disposed at a smaller pitch than a pixel size of the display panel. That is to say, the plurality of slit electrodes are disposed to correspond to one pixel of the display panel.

A common electrode to which common potential is supplied is provided on an entire surface of an opposite substrate paired with a substrate on which the plurality of slit electrodes are disposed, and a space between the substrates is filled with the liquid crystal. in a liquid crystal panel of a normally-white system, the shutter part shielding light is formed when there is a large potential difference between the slit electrode and the common electrode, and the light transmitting part passing the light is formed when the potential difference is small.

In the parallax barrier panel having the above configuration, the potential for making the electrode entering one of the light transmitting state and the light shielding state is applied to each slit electrode so that the light transmitting part and the shutter part move in accordance with a detected position of the viewpoint. Accordingly, even when the observer moves, the image for right eye and the image for left eye are visually recognized separately by the right eye and the left eye, respectively (for example, Japanese Patent Nos. 6057647, 6041992, and 6266067).

### SUMMARY

Although a detail is described hereinafter, a leakage electric field from an electrode which becomes the shutter part occurs in the liquid crystal in a boundary part where the electrode which becomes the shutter part and the electrode which becomes the light transmitting part are adjacent to each other. In accordance with this leakage electric field, there is an area where a reverse tilt in which an orientational state of the liquid crystal is substantially opposite to a normal orientational state occurs in the boundary part.

When the light transmitting part and the shutter part do not move, the reverse tilt is fixed to the area, and when the light transmitting part and the shutter part move, there is no influence of the leakage electric field in the area, and the reverse tilt is resolved as time proceeds. However, immediately after the light transmitting pat and the shutter part move and before the reverse tilt is resolved, a disclination in which the liquid crystal orientation becomes unstable and causes a light leakage occurs near the reverse tilt. When it takes time before the resolution of the disclination, there is a problem that the disclination is visually recognized by the observer as unevenness, and a visual quality is reduced.

The present disclosure therefore has been made to solve the above problems, and it is an object of the present disclosure to provide a technique capable of suppressing a reduction in a visual quality in a display device.

The present disclosure is a display control method of a display device including a display panel and a parallax barrier panel in which a plurality of openings capable of being switched into a light transmitting state and a light shielding state with respect to light of the display panel are arrayed. The display control method performs a control of bringing a predetermined number of openings adjacent to each other out of the plurality of openings into a first state which is one state of the light transmitting state and the light shielding state to form a plurality of first state parts and bringing remaining openings out of the plurality of openings into a second state which is another state of the light transmitting state and the light shielding state, and a control of moving the first state parts at a pitch corresponding to two or more of the openings.

A reduction in a visual quality in a display device can be suppressed. These and other objects, features, aspects and advantages of the present invention will become more apparent from the following detailed description of the present invention when taken in conjunction with the accompanying drawings,

### BRIEF DESCRIPTION OF THE DRAWINGS

FIG. 1 is a cross-sectional view schematically illustrating a configuration of a related display device.

FIG. 2 is a planar view illustrating a parallax barrier panel in the related display device.

FIG. 3 is a cross-sectional view schematically illustrating a configuration of the parallax barrier panel in the related display device.

FIG. 4 is a cross-sectional view schematically illustrating a configuration of the related display device.

FIGS. 5 to 8 are cross-sectional views each schematically illustrating a configuration of the parallax barrier panel in the related display device,

FIG. 9 is a planar view illustrating the parallax barrier panel in the related display device.

FIG. 10 is a planar view illustrating a state of a parallax barrier panel according to an embodiment 1 in an order of change.

FIGS. 11 and 12 are cross-sectional views each schematically illustrating a configuration of the parallax barrier panel according to the embodiment 1.

FIG. 13 is a planar view illustrating a state of a parallax barrier panel according to a modification example of the embodiment 1 in an order of change.

FIG. 14 is a planar view illustrating a state of a parallax barrier panel according to an embodiment 2 in an order of change.

FIG. 15 is a planar view illustrating a state of a parallax barrier panel according to a modification example of the embodiment 2 in an order of change.

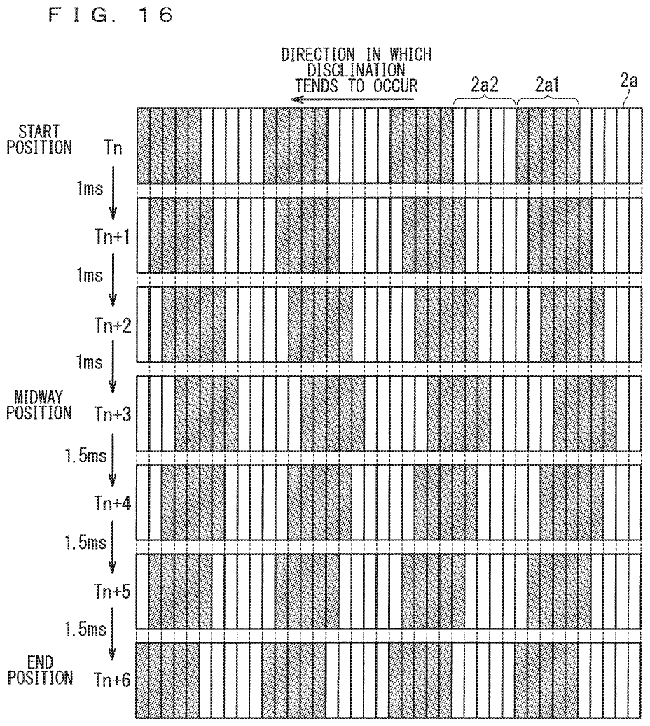

FIG. 16 is a planar view illustrating a state of a parallax barrier panel according to an embodiment 3 in an order of change.

FIGS. 17 and 18 are planar views each illustrating a state of a parallax barrier panel according to a modification example of the embodiment 3 in an order of change.

### DESCRIPTION OF THE PREFERRED EMBODIMENTS

<Related Display Device>

Prior to describing a stereoscopic display device which is a display device according to embodiments of the present invention, a stereoscopic display device relating thereto (referred to as “the related display device” hereinafter) is described firstly.

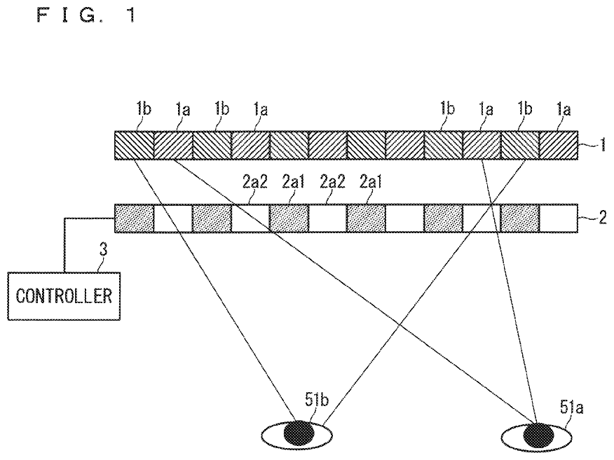

FIG. 1 is a cross-sectional view schematically illustrating a configuration of the related display device. The related display device includes a display panel 1, a parallax harrier panel 2, and a controller 3.

A liquid crystal panel, for example, is used in the display panel 1. Alternately arrayed planarly in the display panel 1 are an image part for right eye 1a which is part of an image for right eye which should be visually recognized by a right eye 51a of an observer and an image part for left eye 1b which is part of an image for left eye which should be visually recognized by a left eye 51b of the observer. The image for right eye and the image for left eye are partially different from each other to such an extent as to cause a parallax.

A twisted nematic type liquid crystal panel which does not include a color filter and a black matrix is used in the parallax barrier panel 2, for example.

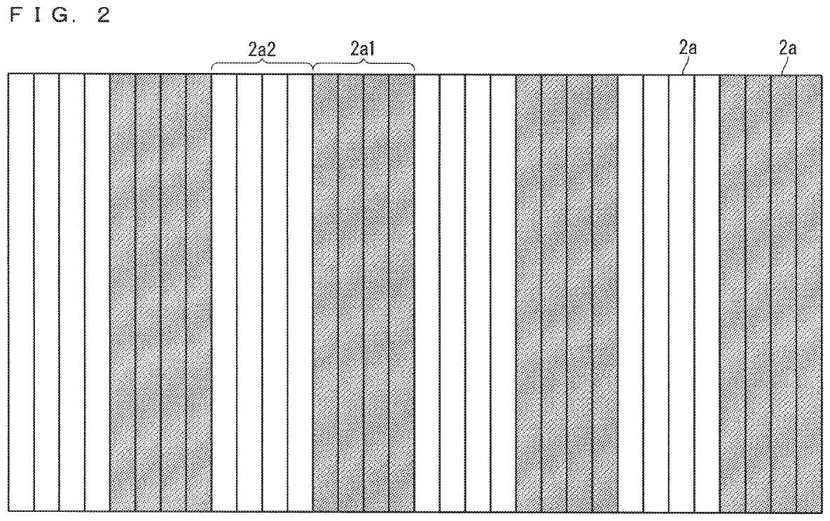

FIG. 2 is a planar view illustrating the parallax barrier panel 2. A plurality of openings 2a having a longitudinal slit shape are arrayed in the same direction as an array direction of the image part for right eye 1a and the image part for left eye 1b (a lateral direction in FIG. 2) in the parallax barrier panel 2. A light transmitting state and a light shielding state with respect to light of the display panel 1 can be switched in the plurality of openings 2a. In the parallax barrier panel 2 in the drawings subsequent to FIG. 1 and FIG. 2, a dot hatching is assigned to the opening 2a in the light shielding state, however, the dot hatching is not assigned to the opening 2a in the light transmitting state.

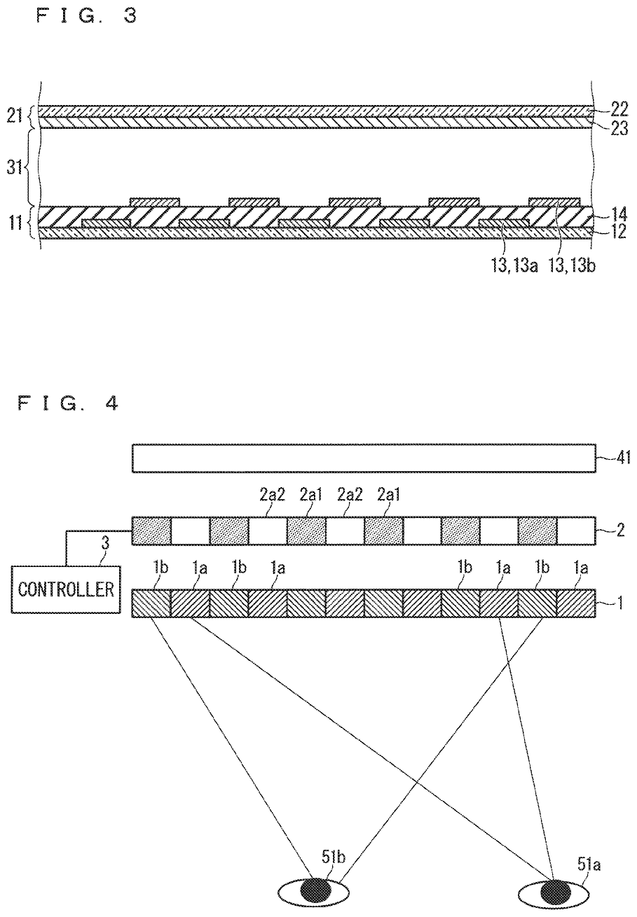

FIG. 3 is a cross-sectional view illustrating a configuration of the parallax barrier panel 2. The parallax barrier panel 2 in FIG. 3 includes an electrode side substrate 11, an opposite substrate 21, and a liquid crystal layer 31. Although not shown in FIG. 3, for example, the parallax barrier panel 2 also includes a switching element, an oriented film, and a polarization film, for example, in a manner similar to a normal liquid crystal panel.

The electrode side substrate 11 includes a transparent substrate 12, a plurality of barrier electrodes 13, and an insulating film 14. Each of the plurality of barrier electrodes 13 is a transparent electrode made of indium tin oxide (ITO), for example, and includes a lower electrode 13a provided on the transparent substrate 12 and an upper electrode 13b provided on the insulating film 14. The harrier electrode 13 is also referred to as the slit electrode.

The plurality of barrier electrode 13 correspond to the plurality of openings 2a in FIG. 2, and a range of each barrier electrode 13 is the same or substantially the same as a range of each opening 2a in a planar view. An AC voltage is appropriately applied to the plurality of barrier electrodes 13 to suppress a burn-in of the liquid crystal caused by a DC voltage. A pitch of the plurality of barrier electrodes 13 corresponds to a pitch of a pixel for the plurality of display panels 1, and at least part of light of the pixel is shielded or transmitted in accordance with the potential of each barrier electrode 13. As illustrated in FIG. 3, the plurality of barrier electrodes 13 are alternately provided in an upper row and a lower row, thus the opening 2a with a small pitch can be achieved.

The opposite substrate 21 and the electrode side substrate 11 sandwich the liquid crystal layer 31. The opposite substrate 21 includes a transparent substrate 22 and a common electrode 23 provided on the transparent substrate 22. Steady potential is applied to the common electrode 23.

Provided on a surface on an opposite side of each of the transparent substrate 12 and the transparent substrate 22 from the liquid crystal layer 31 is a polarization plate for shielding or transmitting the light from the display panel 1 in accordance with the orientational state (the inclination state) of liquid crystal molecules of the liquid crystal layer 31. The oriented film for substantially regulating the orientational state of the liquid crystal molecules of the liquid crystal layer 31 is provided on the surface of each of the transparent substrate 12 and the transparent substrate 22 on the side of the liquid crystal layer 31. When this oriented film is rubbed, a pretilt angle of the liquid crystal molecules is formed.

Herein, when the potential of the barrier electrode 13 is high potential(first potential), the opening 2a corresponding to the barrier electrode 13 enters a first state which is one state of the light transmitting state and the light shielding state. In the meanwhile, when the potential of the barrier electrode 13 is low potential (second potential) lower than the high potential, the opening 2a corresponding to the barrier electrode 13 enters a second state which is the other state of the light transmitting state and the light shielding state. A plurality of first state parts disposed at intervals are formed by a predetermined number of openings 2a adjacent to each other in the first state, and a plurality of second state parts disposed at intervals are formed by remaining openings 2a in the second state.

In the description hereinafter, the parallax barrier panel 2 is a liquid crystal panel of a normally-white system. In this case, the first state is the light shielding state, the first state part is a shutter part 2a1 illustrated in FIG. 2, the second state is the light transmitting state, and the second state part is a light transmitting part 2a2 (an opening part) illustrated in FIG. 2,

However, the parallax barrier panel 2 is not limited thereto, but may be a liquid. crystal panel of a normally-black system, for example. In this case, the first state is the light transmitting state, the first state part is the light transmitting part, the second state is the light shielding state, and the second state part is the shutter part. In the present specification, the potential has substantially the same meaning as the voltage.

A pitch of the shutter part 2a1 and the light transmitting part 2a2 is the same as the pixel pitch of the display panel 1 hereinafter. The number of openings 2a forming the shutter part or the light transmitting part may be appropriately changed as long as the plurality of openings 2a are applied.

According to the above configuration, as illustrated in FIG. 1, the image part for left eye 1b is not entered into the right eye 51a due to the shutter part 2a1, however, the image part for right eye 1a is entered through the light transmitting part 2a2. In the meanwhile, the image part for right eye 1a is not entered into the left eye 51b due to tile shutter part 2a1, however, the image part for left eye 1b is entered through the light transmitting part 2a2. As a result, the observer can visually recognize the stereoscopic display on the stereoscopic display device.

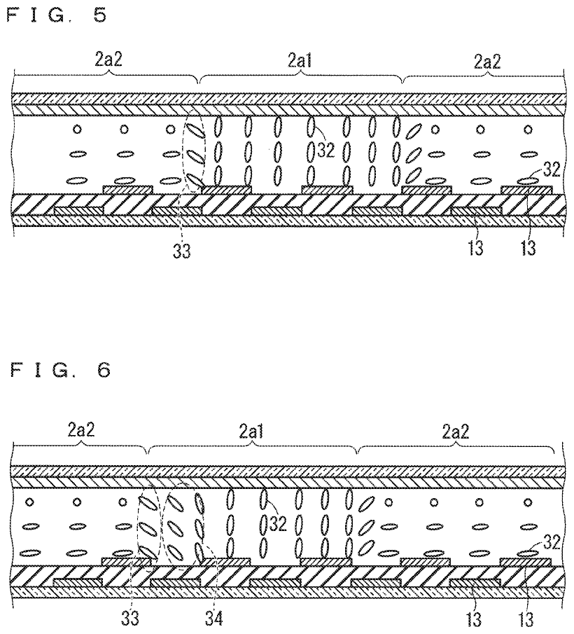

In the example in FIG. 1, the parallax barrier panel 2 is disposed closer to the observer than the display panel 1, however, the configuration is not limited thereto. For example, as illustrated in FIG. 4, the display panel I may be disposed closer to the observer than the parallax barrier panel 2 in a configuration of using light of a backlight 41. Even in such a configuration in FIG. 4, the observer can visually recognize the stereoscopic display on the stereoscopic display device in the manner similar to that in FIG. 1.

The controller 3 illustrated in FIG. 1, etc. includes a central processing unit (CPU), for example, and controls the light transmitting state and the light shielding state of the plurality of openings 2a in the parallax barrier panel 2. The shutter part 2a1 and the light transmitting part 2a2 in FIG. 2 described above are formed by this control.

An observer position detection part made up of a camera provided outside or inside the related display device but not shown in the drawings detects positional information of the observer. The controller 3 controls the light transmitting state and the light shielding state based on the positional information detected in the observer position detection part. The controller 3 controls the light transmitting state and the light shielding state in accordance with a movement of the observer, thereby controlling the shutter part 2a1 and the light transmitting part 2a2 so that they are movable along an array direction (a lateral direction FIG. 2) of the plurality of openings 2a.

Accordingly, the shutter part 2a1 and the light shielding part 2a2 are moved to follow a movement of a position of a viewpoint of the observer so that the position of the viewpoint is located in the area where the stereoscopic image is visually recognized. Thus, even when the observer moves, the image part for right eye 1a and the image part for left eye 1b can be entered into the right eye 51 and the left eye 51b, respectively, thus the observer can visually recognize the stereoscopic display on the stereoscopic display device.

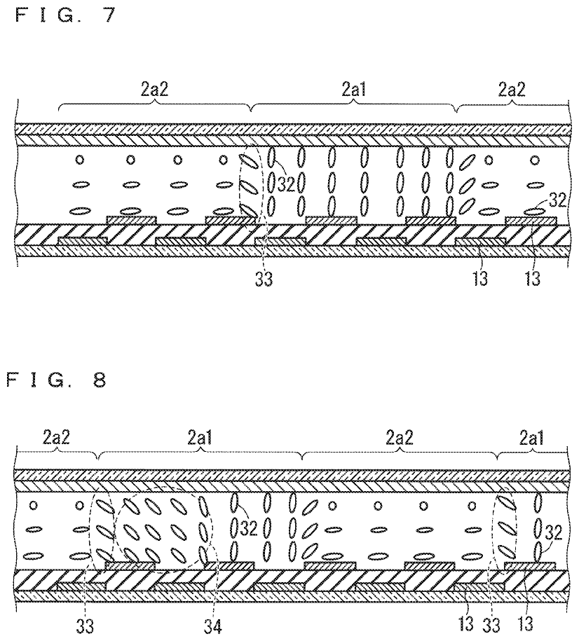

A problem of the related display device is described next. FIG. 5 is a cross-sectional view illustrating an example of an orientational state of liquid crystal molecules 32 in the liquid crystal layer 31 in the parallax barrier panel 2 in the related display device. The illustration of the reference numeral in FIG. 3 is partially omitted in the cross-sectional views in the drawings subsequent to FIG. 5 for simplifying the drawings.

In the normally-white system, when the potential of the barrier electrode 13 is the low potential (for example, the common potential), the liquid crystal molecules 32 around the barrier electrode 13 have the orientational state (for example, the orientational state parallel to the substrate) substantially regulated by the oriented film, and the opening corresponding to the barrier electrode 13 enters the light transmitting state. In the meanwhile, when the potential of the barrier electrode 13 is the high potential, the liquid crystal molecules 32 around the barrier electrode 13 have the orientational state (for example, the orientational state vertical to the substrate) substantially regulated by a longitudinal electric field between the barrier electrode 13 and the common electrode 23, and the opening corresponding to the barrier electrode 13 enters the light shielding state.

Herein, a leakage electric field which is an electric field leaked from the barrier electrode 13 corresponding to the shutter part 2a1 to the light transmitting part 2a2 occurs in a boundary part between the shutter part 2a1 and the light transmitting part 2a2. The leakage electric field occurs in each of a left end portion and a right end portion of the shutter part 2a1 in FIG. 5, and a reverse tilt 33 in which the orientational state of the liquid crystal molecules 32 is substantially opposite to the normal orientational state corresponding the rubbing occurs in one of the end portions (the left end portion in FIG. 5). Then, immediate after the shutter part 2a1 moves, a disclination in which the liquid crystal orientation becomes unstable and causes a light leakage occurs near the reverse tilt 33.

FIG. 6 is a cross-sectional view illustrating the orientational state of the liquid crystal molecules 32 immediate after the shutter part 2a1 moves to a side of the reverse tilt 33 (the left side) by a distance of one barrier electrode 13 from the liquid crystal orientational state in FIG. 5. In FIG. 6, the high potential is applied to the barrier electrode 13 near the reverse tilt 33 in FIG. 5, thus the opening of the barrier electrode 13 is to make a transition from the light transmitting state to the light shielding state However, at this time, a disclination 34 having an orientational state similar to the reverse tilt 33 occurs in a region between the boundary part where the reverse tilt 33 has occurred in the state in FIG. 5 and a boundary part where the reverse tilt 33 has newly occurred in the state in FIG. 6. The region where the disclination 34 has occurred does not completely enter the light shielding state but enters a light leakage state where a small amount of light is transmitted.

The direction in the orientational state of the liquid crystal molecules 32 influenced by the leakage electric field is substantially the same as the direction in the normal orientational state (the forward direction) in accordance with the rubbing in the other end portion (the right end portion in FIG. 5) on an opposite side of one end portion where the reverse tilt 33 has occurred in the left end portion and the right end portion of the shutter part 2a1 in FIG. 5. The other end portion enters the normal light transmitting state where the leakage electric field has been resolved as illustrated in FIG. 6 in accordance with the movement of the shutter part 2a1 and the light transmitting part 2a2. Thus, the disclination does not occur in the other end portion (the right end portion in FIG. 6) on the opposite side of one end portion where the reverse tilt 33 has occurred.

FIG. 7 is a cross-sectional view illustrating the orientational state of the liquid crystal molecules 32 immediately after the shutter part. 2a1 moves to an opposite direction (a right side) of the movement direction in FIG. 6 by the distance of one barrier electrode 13 from the liquid crystal orientational state in FIG. 5. The leakage electric field is resolved and the state returns to the normal orientational state in the left end portion where the reverse tilt has occurred due to the leakage electric field in FIG. 5, thus the disclination does not occur. The liquid crystal molecules 32 are further tilted in the forward direction in the right end portion where the liquid crystal molecules 32 are inclined in the forward direction due to the leakage electric field in FIG. 5, thus the disclination does not occur. As can be seen by the comparison between FIG. 6 and FIG. 7, the occurrence of the disclination 34 depends on the movement direction of the shutter part 2a1 and the light transmitting part 2a2.

The disclination 34 in FIG. 6 which has occurred from the reverse tilt 33 as a starting point recovers to the normal liquid crystal orientational state as time proceeds, and only the reverse tilt 33 remains finally. However, when the shutter part 2a1 further moves to the side of the reverse tilt 33 before the disclination 34 is resolved, the range of disclination increases.

FIG. 8 is a cross-sectional view illustrating the orientational state of the liquid crystal molecules 32 immediate after the shutter part 2a1 moves to the side of the reverse tilt 33 (the left side) by the distance of one barrier electrode 13 from the liquid crystal orientational state in FIG. 6. At this time, the disclination 34 occurs in relatively a large region between the boundary part where the reverse tilt 33 has occurred in the state in FIG. 5 and the boundary part where the reverse tilt 33 has newly occurred in the state in FIG. 8. When the disclination 34 sequentially occurs in this manner and the range thereof increases, the time until the disclination 34 disappears increases, and the disclination 34 remains for a long period of time.

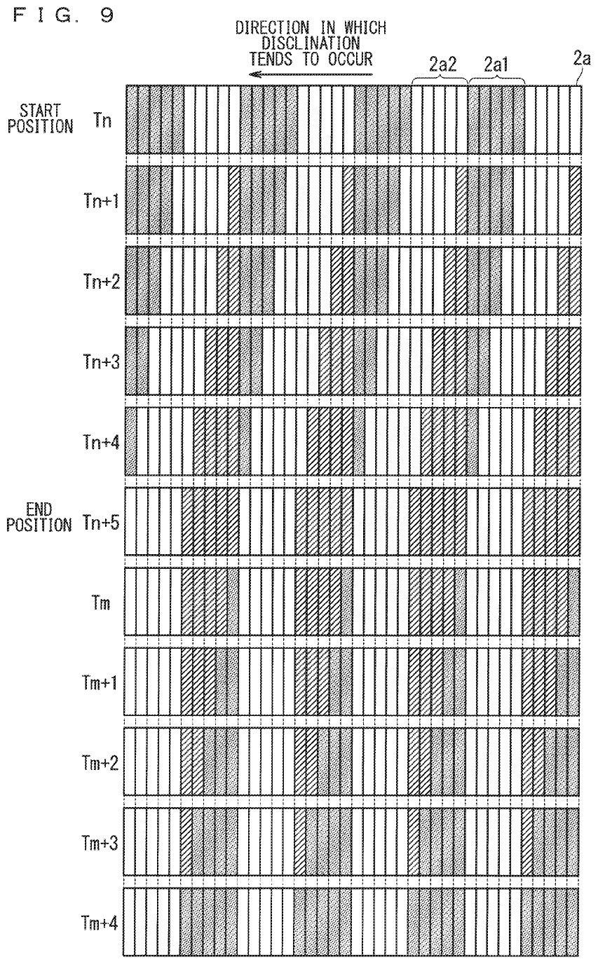

FIG. 9 is a drawing illustrating a state of the opening 2a in the parallax barrier panel 2 in a case where the shutter part 2a1 and the light transmitting part 2a2 move to the side of the reverse tilt (the left side in FIG. 9) in an order of change. In the above description, there are the four opening parts 2a in each of the shutter part 2a1 and the light transmitting part 2a2, however, there are the five opening parts 2a in each of the shutter part 2a1 and the light transmitting part 2a2 in FIG. 9. However, the difference in the number thereof does not have a substantive influence on an operation, for example. The same applies to the description hereinafter.

A state at a timing in FIG. 9 corresponds to the state in FIG. 2. A time between Tn and Tn+1, a time between Tn+1 and Tn+2, and a time between Tn+4 and Tn+5 are approximately the same. In each time, the shutter part 2a1 and the light transmitting part 2a2 moves to the side of the reverse tilt at a pitch corresponding to one barrier electrode 13, that is to say, a pitch corresponding to one opening 2a.

Even when the disclination 34 sequentially occurs (Tn to Tn+5) due to the continuous movement of the shutter part 2a1 and the light transmitting part 2a2 several. times, the disclination 34 is resolved as time proceeds if the shutter part 2a1 and the light transmitting part 2a2 do not move after the occurrence of the disclination 34. However, when the shutter part 2a1 and the light transmitting part 2a2 continuously move several times in this manner, the disclination 34 occurs in relatively a large range (an oblique hatching in FIG. 9), and remains relatively a long period of time.

As a result described above, the influence of the light leakage due to the disclination 34 is relatively large in the related display device, thus the image for right eye and the image for left eye are mixed or unevenness caused by non-uniform illuminance in the shutter part 2a1 is visually recognized in some cases. In contrast, a stereoscopic display device according to embodiments described hereinafter is capable of resolve this problem.

### Embodiment 1

Constituent elements in the stereoscopic display device according to an embodiment 1 of the present invention are substantially the same as those in the related display device. Thus, the same or similar reference numerals as those described in the above embodiments will be assigned to the same or similar constituent element in the configuration according to the present embodiment 1, and the different constituent elements are mainly described hereinafter.

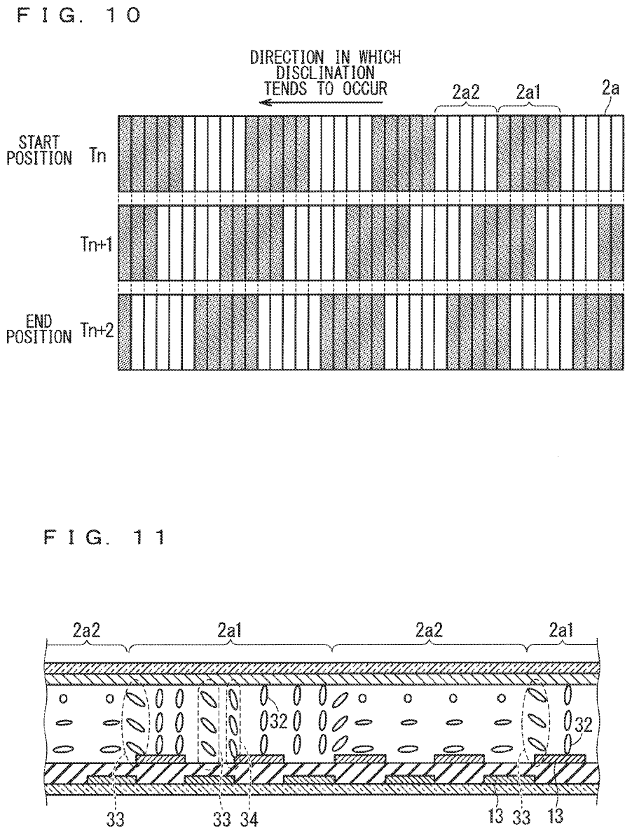

FIG. 10 is a planar view illustrating a state of the opening 2a in the parallax barrier panel 2 controlled by the controller 3 according to the present embodiment 1 in an order of change. In FIG. 10, the shutter part 2a1 and the light transmitting part 2a2 continuously move several times (twice) in the side of the reverse tilt (the left side) from the timing Tn in a start position to the timing Tn+2 in an end position.

As illustrated in FIG. 10, the controller 3 according to the present embodiment 1 performs a control of moving the shutter part 2a1 and the light transmitting part 2a2 at a pitch corresponding to the two openings 2a for each of the several movements. As a result, the end position of the movement of each shutter part 2a1 and each light transmitting part 2a2 is located in a position shifting from the start positon in a direction (the left direction) in which the disclination 34 which is an orientation anomalous region. tends to occur.

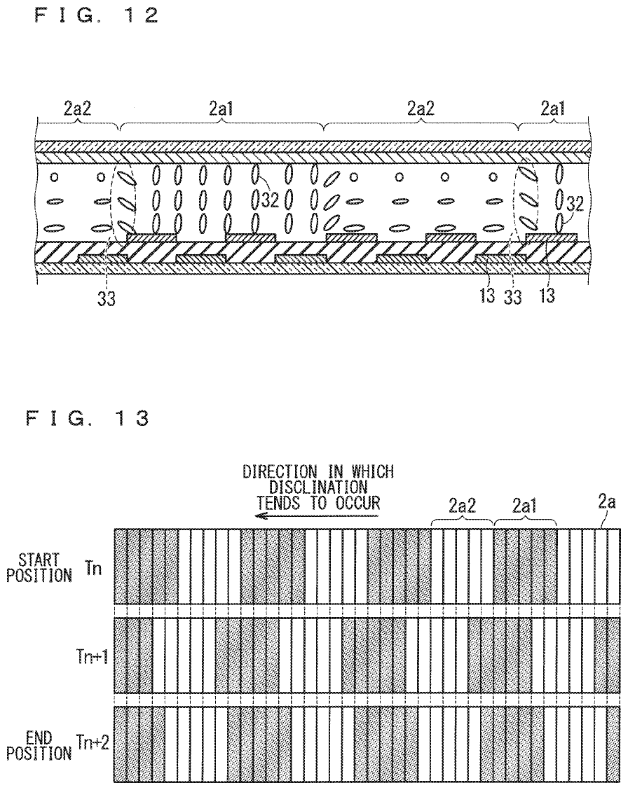

FIG. 11 is a cross-sectional view schematically illustrating a configuration of a parallax barrier panel according to the present embodiment 1. Specifically, an orientational state of the liquid crystal molecules 32 at the timing Tn in FIG. 10 corresponds to the orientational state in FIG. 6, and an orientational state of the liquid crystal molecules 32 at the timing Tn+1 in FIG. 10 corresponds to the orientational state in FIG. 11.

There are small amounts of the liquid crystal molecules 32 in the state of the reverse tilt 33 and the disclination 34 illustrated in FIG. 6, etc. immediately after the potential is changed also in the present embodiment 1 as illustrated in FIG. 11. However, the direction of the liquid crystal molecules 32 located on the both sides of the liquid crystal molecules 32 which enter the state of the reverse tilt 33 and the disclination 34 in both FIG. 6 and FIG. 11 is the normal tilt direction (the direction vertical to the substrate in FIG. 11). Thus, the liquid crystal molecules 32 which are in the state of the reverse tilt 33 and the disclination 34 are promoted to be inclined in the normal tilt direction. Accordingly, a continuous connection of the reverse tilt 33 can be suppressed, thus the range of the disclination 34 can be reduced. As a result, as illustrated in FIG. 12, the state where the reverse tilt 33 and the disclination 34 are resolved can be obtained in a short period of time.

The pitch of the movement to the side of the reverse tilt is the pitch corresponding to the two openings 2a in FIG. 10, however, the configuration is not limited thereto, thus the pitch may correspond to the three or more openings 2a.

The pitch of the movement to the side of the reverse tilt is described above. In contrast, the pitch of the movement to the opposite side (the right side) of the reverse tilt may be the pitch corresponding to one opening 2a, or the pitch corresponding to the two or more openings 2a.

### Conclusion of Embodiment 1

The controller 3 in the stereoscopic display device according to the present embodiment I described above performs a control of moving the shutter part 2a1 and the light transmitting part 2a2 at a pitch corresponding to the two or more openings 2a. According to such a configuration, the occurrence time of the disclination can be reduced, thus a reduction in a visual quality in the stereoscopic display device due to the disclination can be suppressed.

### Modification Example of Embodiment 1

In the embodiment 1, the controller 3 cannot move the shutter part 2a1 and the light transmitting part 2a2 to a desired end position in some cases. For example, when the controller 3 performs a control of moving the shutter part 2a1 and the light transmitting part 2a2 at the pitch corresponding to an even number of openings 2a, the shutter part 2a1 and the light transmitting part 2a2 cannot be moved to a final position a distance corresponding to an odd number of openings 2a away from the start position.

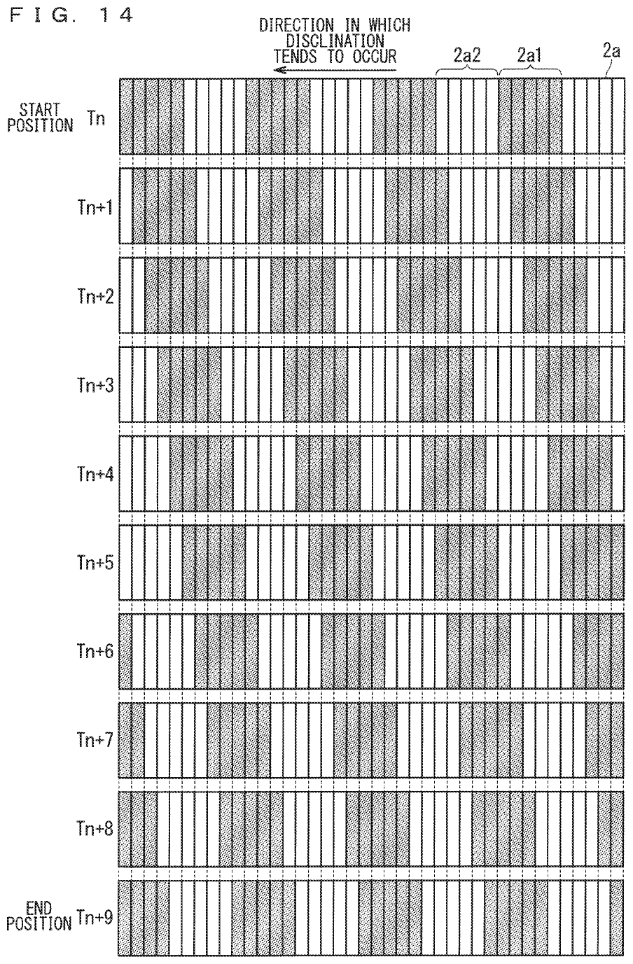

Thus, as illustrated in FIG. 13, the controller 3 may perform, after the shutter part 2a1 and the light transmitting part 2a2 are moved in the direction of the reverse tilt 33 (a first direction) at a pitch corresponding to the two or more openings 2a, a control of moving the shutter part 2a1 and the light transmitting part 2a2 in the opposite direction (a second direction) at a pitch corresponding to the opening 2a which is smaller than the two or more openings 2a in number. In the example in FIG. 13, the two or more openings 2a indicate the two openings 2a, the direction of the reverse tilt 33 indicates the left direction, the opening 2a which is smaller in number indicates one opening 2a, and the opposite direction indicates the right direction. According to such a configuration, the shutter part 2a1 and the light transmitting part 2a2 can be moved to the desired end position.

### Embodiment 2

Constituent elements in the stereoscopic display device according to an embodiment 2 of the present invention are substantially the same as those described above. Thus, the same or similar reference numerals as those described in the above embodiments will be assigned to the same or similar constituent element in the configuration according to the present embodiment 2, and the different constituent elements are mainly described hereinafter.

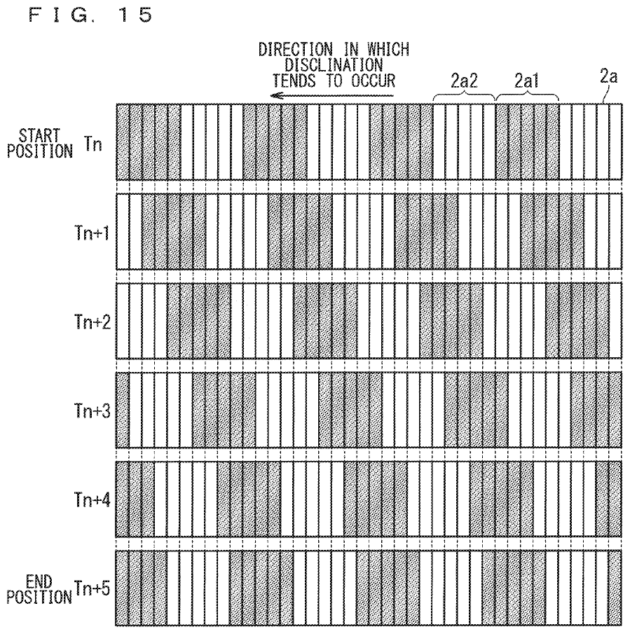

FIG. 14 is a planar view illustrating a state of the opening 2a in the parallax barrier panel 2 controlled by the controller 3 according to the present embodiment 2 in an order of change in FIG. 14, the shutter part 2a1 and the light transmitting part 2a2 continuously move nine times to the opposite side of the reverse tilt (the right side) from the timing Tn in a start position to the timing Tn+9 in an end position.

As illustrated in FIG. 14, the controller 3 according to the present embodiment 2 performs a control of moving the shutter part 2a1 and the light transmitting part 2a2 at a pitch corresponding to one opening 2a only in the right direction (the predetermined one direction) for each of the several movements. As a result, the end position of the each movement of each shutter part 2a1 and each light transmitting part 2a2 is located in a position shifting from the start position in a direction (the right direction) in which the disclination 34 which is an orientation anomalous region hardly occurs. When only the start position at the timing Tn and the end position at the tuning Tn+9 are compared, the shutter part 2a1 and the light transmitting part 2a2 substantially move to the direction in which the disclination 34 tends to occur. The state in FIG. 7 is repeated during this movement, thus the occurrence of the disclination 34 is suppressed.

### Conclusion of Embodiment 2

The controller 3 in the stereoscopic display device according to the present embodiment 2 described above performs a control of moving the shutter part 2a1 and the light transmitting part 2a2 at a pitch corresponding to one opening 2a only in the predetermined direction. According to such a configuration, the movement in the direction in which the disclination 34 hardly occurs can be used as a substitute for the movement in the direction in which the disclination 34 tends to occur. The occurrence of the disclination can be reduced, thus the reduction in the visual quality in the stereoscopic display device due to the disclination can be suppressed.

### Modification Example of Embodiment 2

In the embodiment 2, the pitch of the movement is the pitch corresponding to one opening 2a (FIG. 14), but is not limited thereto. The pitch of the movement may be the pitch corresponding to the two openings 2a, or may also be the pitch corresponding to the three or more openings 2a. According to such a configuration, the time taken tier the movement of the shutter part 2a1 and the light transmitting part 2a2 from the start position to the end position can be reduced, thus the interference of the image for right eye and the image for left eye at the time of the movement can be reduced.

### Embodiment 3

Constituent elements in the stereoscopic display device according to an embodiment 3 of the present invention are substantially the same as those described above. Thus, the same or similar reference numerals as those described in the above embodiments will be assigned to the same or similar constituent element in the configuration according to the present embodiment 3, and the different constituent elements are mainly described hereinafter.

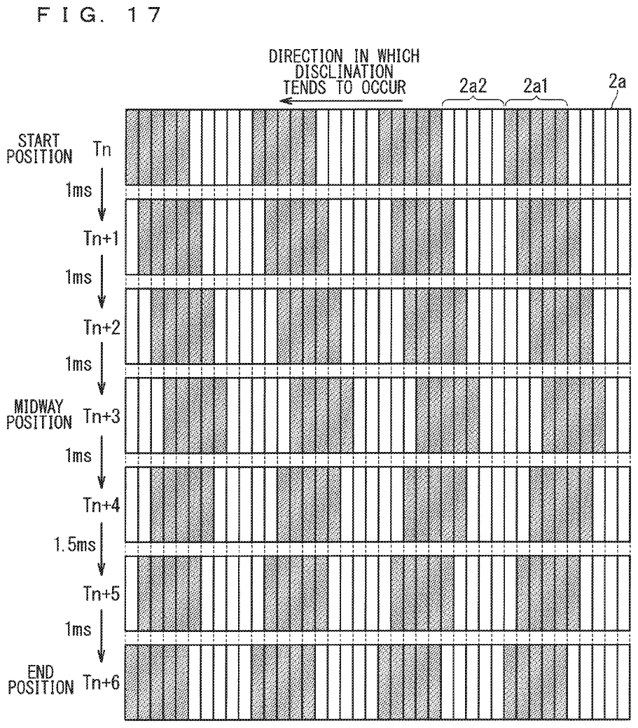

FIG. 16 is a planar view illustrating a state of the opening 2a in the parallax barrier panel 2 controlled by the controller 3 according to the present embodiment 3 in an order of change. In FIG. 16, the shutter part 2a1 and the light transmitting part 2a2 continuously move three times to the opposite side of the reverse tilt (the right side) from the timing Tia in a start position to the timing Tn+3 in a midway position. Subsequently, the shutter part 2a1 and the light transmitting part 2a2 continuously move three times to the side of the reverse tilt (the left side) from the timing Tn+3 in the midway position to the timing Tri+6 in an end position.

As illustrated in FIG. 16, in the present embodiment 3, a first time in which the shutter part 2a1 and the light transmitting part 2a2 are moved to the direction of the reverse tilt 33 (the first direction) at the pitch corresponding to one opening 2a is longer than a second time in which the shutter part 2a1 and the light transmitting part 2a2 are moved to the opposite direction of the direction of the reverse tilt 33 (the second direction) at the pitch corresponding to one opening 2a. In the example in FIG. 16, the direction of the reverse tilt 33 is the left direction, the first time is 1.5 ms, the opposite direction is the right direction, and the second time is 1 ms.

### Conclusion of Embodiment 3

In the stereoscopic display device according to the present embodiment 3 described above, the first time in which the shutter part 2a1 and the light transmitting part 2a2 are moved to the first direction at the pitch corresponding to one opening 2a is longer than the second time in which the shutter part 2a1 and the light transmitting part 2a2 are moved to the second direction which is the opposite direction of the first direction at the pitch corresponding to one opening 2a. According to such a configuration, the connection of the reverse tilt 33 in the short period of time can be suppressed, thus the range of the disclination 34 can be reduced. Accordingly, the occurrence time of the disclination can be reduced, thus the reduction in the visual quality in the stereoscopic display device due to the disclination can be suppressed.

### Modification Example of Embodiment 3

In the example in FIG. 16 according to the embodiment 3, the time taken for the movement of the shutter part 2a1 and the light transmitting part 2a2 at the pitch corresponding to one opening 2a is the first time in all of the several movements to the side of the reverse tilt (the left side). Specifically, each of the time between the timing Tn+3 and the timing Tn+4, the time between the timing Tn±4 and the timing Tn+5, and the time between the timing Tn+5 and the timing Tn+6 is the first time.

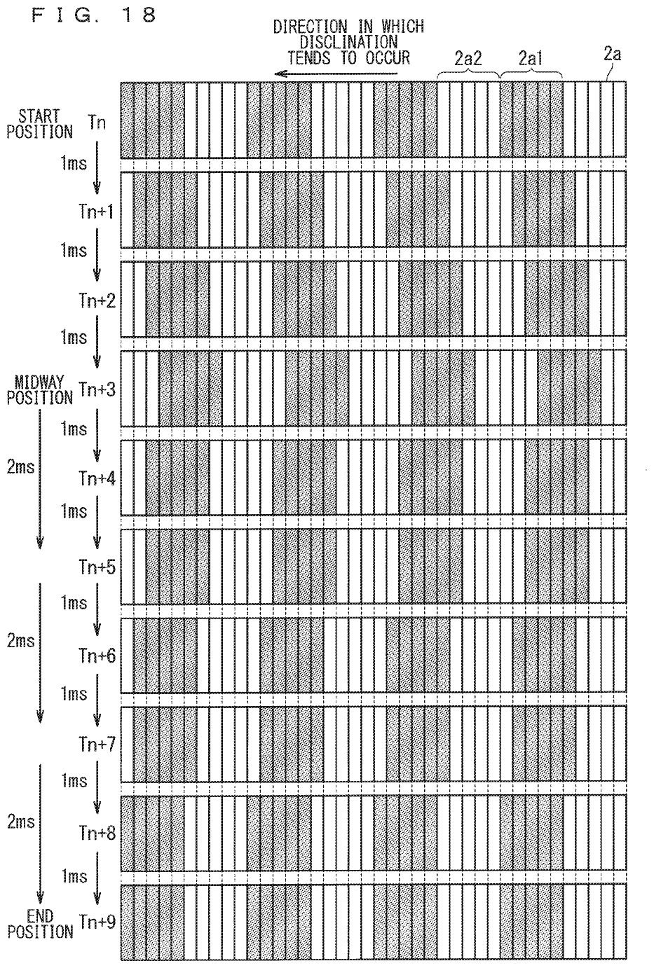

However, the time is not limited thereto, thus as illustrated in FIG. 17, the time taken for the movement of the shutter part 2a1 and the light transmitting part 2a2 at the pitch corresponding to one opening 2a may be the first time in at least one of the several movements of the shutter part 2a1 and the light transmitting part 2a2 to the side of the reverse tilt (the left side). In the example in FIG. 17, the time taken for the midway movement in the several movements (the time between the timing Tn+4 and the timing Tn+5) is the first time, and the time taken for the other movement (the time between the timing Tn+3 and Tn+4 and the time between the timing Tn+5 and Tn+6) is the second time. Even in such a configuration, the reduction in the visual quality in the stereoscopic display device due to the disclination can be suppressed in the manner similar to the embodiment 3.

As illustrated in FIG. 18, when k is defined as a natural number equal to or larger than 2, the first time may be k times as large as the second time. In the example in FIG. 18, k=2 is satisfied, and the same drive signal is applied to the parallax barrier panel 2 at the timing Tn+4 and the timing Tn+5. In the similar manner, the same drive signal is applied to the parallax barrier panel 2 at the timing Tn+6 and the timing Tn+7, and the same drive signal is applied to the parallax barrier panel 2 at the timing Tn+8 and the timing Tn+9. Even in such a configuration, the reduction in the visual quality in the stereoscopic display device due to the disclination can be suppressed in the manner similar to the embodiment 3.

According to the present invention, each embodiment can be arbitrarily combined, or each embodiment can be appropriately varied or omitted within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A display control method of a display device, wherein
the display device includes:
a display panel; and.
a parallax barrier panel in which a plurality of openings capable of being switched into a light transmitting state and a light shielding state with respect to light of the display panel are arrayed, wherein
performed are a control of bringing a predetermined number of openings adjacent to each other out of the plurality of openings into a first state which is one state of the light transmitting state and the light shielding state to form a plurality of first state parts and bringing remaining openings out of the plurality of openings into a second state which is another state of the light transmitting state and the light shielding state, and a control of moving the first state parts at a pitch corresponding to two or more of the openings.

2. The display control method according to claim 1, wherein
performed, after the first state parts are moved in a first direction at a pitch corresponding to the two or more of the openings, is a control of moving the first state parts in a second direction which is an opposite direction of the first direction at a pitch corresponding to at least one of the openings smaller than the two or more of the openings in number.

3. The display control method according to claim 1, wherein
an end position of a movement of each of the first state parts is located in a position shifting from a start position in a direction in which an orientation anomalous region tends to occur.

4. A display control method of a display device, wherein
the display device includes:
a display panel; and
a parallax barrier panel in which a plurality of openings capable of being switched into a light transmitting state and a light shielding state with respect to light of the display panel are arrayed, wherein
performed are a control of bringing a predetermined number of openings adjacent to each other out of the plurality of openings into a first state which is one state of the light transmitting state and the light shielding state to forma plurality of first state parts and bringing remaining openings out of the plurality of openings into a second state which is another state of the light transmitting state and the light shielding state, and a control of moving the first state parts at a pitch corresponding to one or more of the openings only in a predetermined one direction.

5. The display control method according to claim 4, wherein
an end position of a movement of each of the first state parts is located in a position shifting from a start position in a direction in which an orientation anomalous region hardly occurs.

6. A display control method of a display device, wherein
the display device includes:
a display panel; and
a parallax barrier panel in which a plurality of openings capable of being switched into a light transmitting state and a light shielding state with respect to light of the display panel are arrayed, wherein
performed are a control of brining a predetermined number of openings adjacent to each other out of the plurality of openings into a first state which is one state of the light transmitting state and the light shielding state to form a plurality of first state parts and bringing remaining openings out of the plurality of openings into a second state which is another state of the light transmitting state and the light shielding state, and a control of moving the first state parts, and
a first time in which the first state parts are moved to a first direction at a pitch corresponding to one of the openings is longer than a second time in which the first state parts are moved to a second direction which is an opposite direction of the first direction at the pitch.

7. The display control method according to claim 6, wherein
a time taken to move the first state parts at the pitch in the first direction is the first time in at least one of movements of the first state parts performed several times in a case where the movements of the first state parts are performed several times in the first direction.
